(19) United States
(12) Patent Application Publication
(10) Pub. No.: US 2017/0196026 A1
(43) Pub. Date: Jul. 6, 2017

(54) CONTROLLING WIRELESS SUBSCRIPTION SELECTION OF A UICC WITH MULTIPLE CELLULAR PROFILES

(71) Applicant: General Motors LLC, Detroit, MI (US)

(72) Inventors: Ayman R. DAOUD, Plymouth, MI (US); David GEORGE, Farmington Hills, MI (US)

(21) Appl. No.: 14/989,385

(22) Filed: Jan. 6, 2016

(51) Int. Cl. H04W 76/00; H04W 4/22; H04W 4/02; H04L 29/08; H04W 4/16

(52) U.S. Cl. CPC H04W 76/007; H04L 67/303; H04W 4/16; H04W 4/021; H04W 4/22

(57) ABSTRACT

A system and method of controlling selection of cellular profiles at a vehicle includes: detecting a call placed at the vehicle equipped with a vehicle telematics unit that subscribes to cellular service provided by a wireless carrier system; detecting, at the vehicle telematics unit, one or more cell towers providing service only for a different wireless carrier system; directing the vehicle telematics unit to stop use of a cellular profile configured for the wireless carrier system and begin use of a different cellular profile configured for the different wireless carrier system; and placing the call from the vehicle telematics unit using the different cellular profile and a cell tower belonging to the different wireless carrier system.

### TECHNICAL FIELD

The present invention relates to wireless communications and, more particularly, to controlling a Universal Integrated Circuit Card (UICC) that stores multiple cellular profiles.

### BACKGROUND

A wireless carrier system deploys a relatively large number of cell towers over a geopolitical area, such as a city or state, to reliably service subscribers using wireless devices as they travel from one area to another. Despite the large number of cell towers, the wireless carrier system may nonetheless still have a number of areas where they are unable to provide service to their subscribers. However, this does not mean that these areas lack cellular service entirely. Rather, it usually means that a competing wireless carrier system has deployed its own cell towers for servicing subscribers using the competing system. In some areas, a subscriber who lingers in an area serviced by the competing wireless carrier system can still enjoy service thanks to reciprocal usage agreements—often called “roaming”—that allows cellular access. But sometimes the wireless carrier system and other competing wireless carrier systems may not permit their respective subscribers to access each others' cell towers.

This can cause a problem in an emergency. When a subscriber associated with the wireless carrier system can only receive signals from cell towers operated by a competing wireless carrier system, the user may not be able to place emergency calls even though a functioning cell tower is available. It would be helpful to configure the wireless device to temporarily function with the cell towers of the competing wireless carrier system during emergencies.

### SUMMARY

According to an embodiment of the invention, there is provided a method of controlling selection of cellular profiles at a vehicle. The method includes detecting a call placed at the vehicle equipped with a vehicle telematics unit that subscribes to cellular service provided by a wireless carrier system; detecting, at the vehicle telematics unit, one or more cell towers providing service only for a different wireless carrier system; directing the vehicle telematics unit to stop use of a cellular profile configured for the wireless carrier system and begin use of a different cellular profile configured for the different wireless carrier system; and placing the call from the vehicle telematics unit using the different cellular profile and a cell tower belonging to the different wireless carrier system.

According to another embodiment of the invention, there is provided a method of controlling selection of cellular profiles at a vehicle. The method includes detecting a call placed at the vehicle equipped with a vehicle telematics unit that subscribes to cellular service provided by a wireless carrier system; detecting one or more failed attempts by the vehicle telematics unit to place the call; directing the vehicle telematics unit to begin using a different cellular profile configured for a different wireless carrier system that is stored in a Universal Integrated Circuit Chip (UICC), wherein use of the different cellular profile is begun in response to the failed attempts to place the call; and placing the call from the vehicle telematics unit using the different cellular profile.

According to yet another embodiment of the invention, there is provided a method of controlling selection of cellular profiles at a vehicle. The method includes storing a first cellular profile configured for a wireless carrier system and a second cellular profile configured for a different wireless carrier system on a Universal Integrated Circuit Chip (UICC); detecting a call at the vehicle equipped with a vehicle telematics unit that subscribes to cellular service provided by the wireless carrier system and includes the UICC; determining that cellular service is unavailable at the vehicle telematics unit via the wireless carrier system; directing the vehicle telematics unit to stop using the first cellular profile and begin using the second cellular profile; and placing the call using the different cellular profile.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of controlling selection of cellular profiles at a vehicle.

### DETAILED DESCRIPTION OF THE ILLUSTRATED EMBODIMENT(S)

The system and method described below controls the selection of cellular profiles at a vehicle. Wireless devices for cellular communications subscribe to services offered by a wireless carrier system. The wireless carrier system provides a cellular profile to the wireless device for accessing cellular service using that system. Sometimes different wireless carrier systems may not offer cellular service to non-subscribers because of competition with other wireless carrier systems. So the cellular profile used to access the wireless carrier system will not allow access to different wireless carrier systems. As a result, one or more additional cellular profiles capable of accessing different wireless carrier systems can be alternately used to ensure that calls can be made despite the existence of economic competition between wireless carrier systems. Calls can be made using the different wireless carrier system and different cellular profile(s) in an emergency, based on location of the vehicle, or based on a type of service that may require a higher quality connection than is available via the existing cellular profile.

### Communications System —

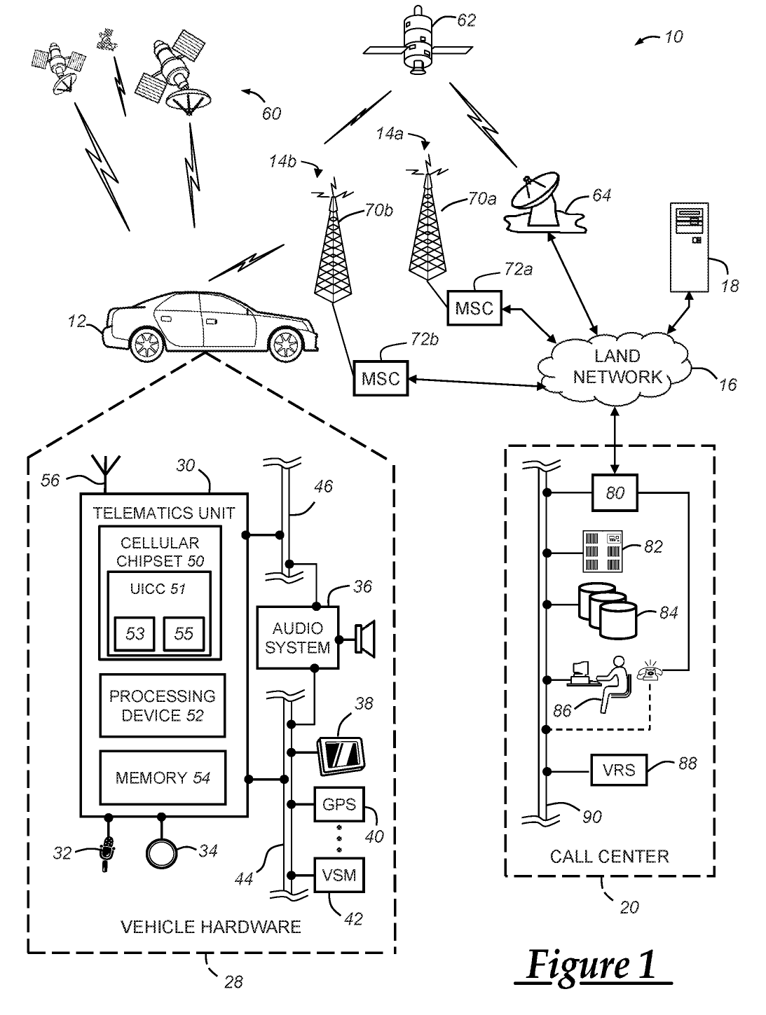

With reference to FIG. 1, there is shown an operating environment that comprises a mobile vehicle communications system 10 and that can be used to implement the method disclosed herein. Communications system 10 generally includes a vehicle 12, a plurality of wireless carrier systems 14a and 14b, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14a and/or a different wireless carrier system 14b as well as via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier systems 14a or 14b so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

The cellular chipset 50 can include a Universal Integrated Circuit Card (UICC) 51 that stores two or more cellular profiles used to access the wireless carrier systems 14a and 14b. The UICC 51 can include a central processing unit (CPU), an electronically erasable programmable read only memory (EEPROM), and input-output circuits that collectively permit the storage of subscriber identity in the form of cellular profiles—more specifically, a cellular profile 53 and a different cellular profile 55. The cellular profiles 53 and 55 can also be referred to as a first cellular profile and a second cellular profile. Cellular profiles generally include information that allows a wireless device associated with a subscriber to access a particular wireless carrier system. This information can include an International Mobile Subscriber Identity (IMSI) that identifies the particular wireless carrier system the wireless device is authorized to used as well as the wireless device, such as the vehicle telematics unit 30. For example, the IMSI can include a mobile country code (MCC), a mobile network code (MNC), and/or a mobile subscription identification number (MSIN). These elements can uniquely identify a subscriber to a wireless carrier system that provides cellular service. The cellular profile 53 can include information that allows a wireless device to access the wireless carrier system 14a while the different cellular profile 55 can include information allowing the wireless device to access the different wireless carrier system 14b. One or both of the cellular profiles 53 and 55 can be supplied to the vehicle telematics unit 30 wirelessly from the wireless carriers 14a and 14b, the call center 20, or other similar remote facility.

When a cell tower receives information in the IMSI, the cell tower can determine whether or not to grant or deny access to the wireless carrier system based on that information. For instance, the cell tower 70b can receive information in an IMSI stored in the cellular profile 53. In this example, the cell tower 70b can pass the information to the wireless carrier system 14b that determines the wireless device, such as the vehicle telematics unit 30, is not a valid subscriber. This determination can take place in a variety of ways, such as searching the home location register (HLR) for content from the received IMSI. The wireless carrier system 14b can then transmit the denial of service to the cell tower 70b. Sometimes the wireless carrier system 14b may allow cellular communications to non-subscribers under agreements with the wireless carrier system that regularly provides cellular service to the non-subscriber. However, the present system and method is directed to an environment in which the wireless carrier system 14a and the different wireless carrier system 14b are competitors and as a result may not offer cellular service to subscribers of competitors under “roaming” agreements. That is, the cellular profile 53 may not be used with cell tower 70b and the different cellular profile 55 may not be used with the cell tower 70a. This will be discussed in more detail below.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14a and a different wireless carrier system 14b are preferably cellular telephone systems that each includes a plurality of cell towers 70a and 70b. FIG. 1 depicts only one cell tower for each wireless carrier system (the cell tower 70a belonging to wireless carrier system 14a and the cell tower 70b belonging to wireless carrier system 14b) but it should be appreciated that each system includes many cell towers. The wireless carrier systems 14a and 14b each include one or more mobile switching centers (MSCs) 72a and 72b, respectively, as well as any other networking components required to connect wireless carrier system 14 with land network 16. Each cell tower 70a and 70b includes sending and receiving antennas and a base station, with the base stations from different cell towers being connected to the MSCs 72a and 72b either directly or via intermediary equipment such as a base station controller. Wireless carrier systems 14a and 14b can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless carrier systems 14a and 14b. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier systems 14a and 14b, satellite communications can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier systems 14a and 14b.

Land network 16 may be a conventional land-based telecommunications network that is connected to one or more landline telephones and connects wireless carrier systems 14a and 14b to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier systems 14a and 14b.

Computer 18 can be one of a number of computers accessible via a private or public network such as the Internet. Each such computer 18 can be used for one or more purposes, such as a web server accessible by the vehicle via telematics unit 30 and wireless carrier systems 14a and 14b. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method —

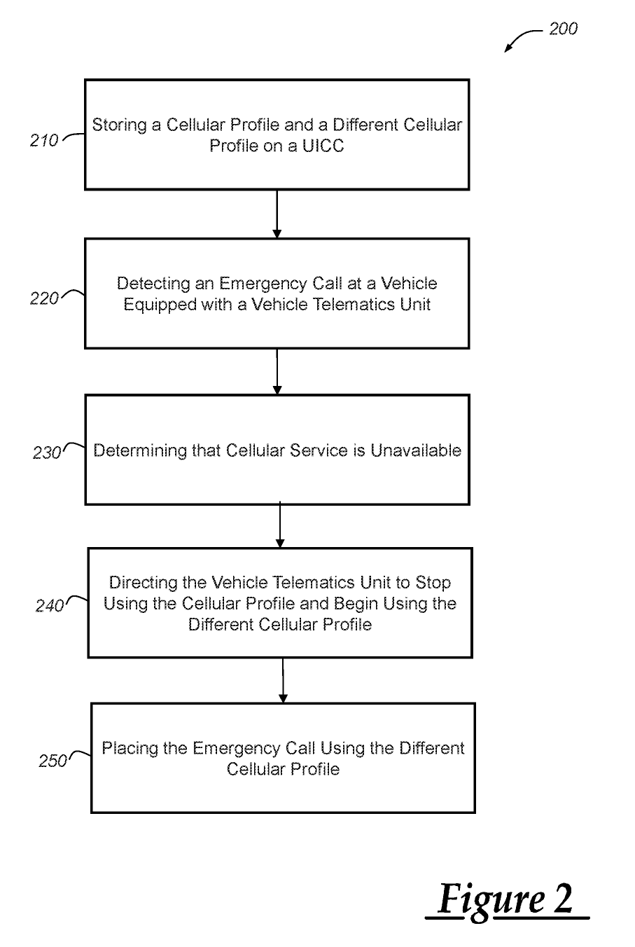

Turning now to FIG. 2, there is a method 200 of controlling selection of cellular profiles at the vehicle 12. The method 200 begins at step 210 by storing a cellular profile 53 and a different cellular profile 55 on the UICC 51. The cellular profile 53 is configured for the wireless carrier system 14a and the second cellular profile 55 is configured for the different wireless carrier system 14b. That is, rather than including a single wireless profile, the vehicle telematics unit 30 can store more than one profile at least one of which provides limited capability to access one or more wireless carrier systems other than the wireless carrier system that mainly provides cellular service. During normal operation, the vehicle telematics unit 30 can carry out cellular communications using the cellular profile 53. The cellular profile 53 includes information—such as the IMSI—that permits the vehicle telematics unit 30 to wirelessly place calls and/or transmit data via the wireless carrier system 14a. When using the cellular profile 53, the vehicle telematics unit 30 may not be able to place calls and/or transmit data via the different wireless carrier system 14b. Normal operation should be understood to refer to all wireless cellular communications that are not related to emergency events. Emergency events can include a call to a public safety access point (PSAP), a detected collision via airbag activation, or some other condition that requires urgent communications with the vehicle 12. In addition to emergency events, the second cellular profile 55 can be selected based on a desired quality of service, a particular location, or both. While the method 200 is described with respect to emergency calls, it should be understood that other non-emergency events can be used to switch cellular profiles. The method 200 proceeds to step 220.

At step 220, an emergency call is detected at the vehicle 12 equipped with the vehicle telematics unit 30 that subscribes to cellular service provided by the wireless carrier system 14a. The vehicle 12 can determine whether a voice or data call placed using the vehicle telematics unit 30 is of an emergency nature or has been initiated by an emergency event. As noted above, the vehicle telematics unit 30 can determine that the call is placed to a PSAP or that the call is automatically placed in response to an airbag activation. These type of calls can be labeled emergency calls and given a higher priority relative to other calls made from the vehicle 12. The method 200 proceeds to step 230.

At step 230, it is determined that cellular service is unavailable at the vehicle telematics unit 30 via the wireless carrier system 14a. In one implementation, this includes detecting one or more failed attempts by the vehicle telematics unit 30 to place the emergency call. The vehicle telematics unit 30 can attempt and fail to place the emergency call one or more times using the cell tower 70a of the wireless carrier system 14a. A defined number of failed attempts can indicate that cellular service is not available for the emergency call. In another implementation, the vehicle telematics unit 30 can scan the area for cell towers and determine that only cell towers belonging to the different wireless carrier system 14b are available, such as the cell tower 70b. The existence of the emergency call along with an inability to place the emergency call can initiate use of the different cellular profile 55 and the different wireless carrier system 14b by the vehicle telematics unit 30. The method 200 proceeds to step 240.

At step 240, the vehicle telematics unit 30 is directed to stop using the cellular profile 53 and begin using the different cellular profile 55. Once it is determined that an emergency call exists and that cellular service using the cellular profile 53 and wireless carrier system 14b is not available, the vehicle telematics unit 30 can direct itself to begin using the different cellular profile 55. An instruction can be generated by the processor 52 that directs the vehicle telematics unit 30 to begin using the different cellular profile 55 configured for the different wireless carrier system 14b. In response, the cellular chipset 50 can begin use of the different cellular protocol 55 that is stored in the UICC 51. The different cellular profile 55 can be used while the vehicle telematics unit 30 is placing emergency calls, the wireless carrier system 14a is unavailable, or both. The method 200 proceeds to step 250.

At step 250, the emergency call is placed using the different cellular profile 55. The vehicle telematics unit 30 can place the emergency call via the different cell tower 70b and different wireless carrier system 14b using the credentials or information available in the different cellular protocol 55. The different cellular profile 55 can then be used while the vehicle telematics unit 30 is placing emergency calls, the wireless carrier system 14a is unavailable, or both. After the emergency call(s) are successfully placed or the wireless carrier system 14b becomes available again, the vehicle telematics unit 30 can begins using the cellular profile 53 to place calls using the wireless carrier system 14a. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of controlling selection of cellular profiles at a vehicle, the steps comprising:
(a) detecting a call placed at the vehicle equipped with a vehicle telematics unit that subscribes to cellular service provided by a wireless carrier system;
(b) detecting, at the vehicle telematics unit, one or more cell towers providing service only for a different wireless carrier system;
(c) directing the vehicle telematics unit to stop use of a cellular profile configured for the wireless carrier system and begin use of a different cellular profile, wherein the vehicle stores the International Mobile Subscriber Identity (IMSI) and Mobile Subscription Identification Number (MSIN) configured for the wireless carrier system with the cellular profile and a different IMSI and different MSIN configured for the different wireless carrier system with the different cellular profile;
(d) providing information from the different IMSI included in the different cellular profile to a cell tower; and
(e) placing the call from the vehicle telematics unit using the different cellular profile and a cell tower belonging to the different wireless carrier system.

2. The method of claim 1, wherein the call results from an airbag activation or a call to a public safety access point (PSAP).

3. The method of claim 1, wherein the cellular profile and the different cellular profile are stored in a Universal Integrated Circuit Chip (UICC).

4. The method of claim 1, further comprising the step of wirelessly receiving the cellular profile, the different cellular profile, or both from a remote facility.

5. A method of controlling selection of cellular profiles at a vehicle, the steps comprising:
(a) detecting a call placed at the vehicle equipped with a vehicle telematics unit that subscribes to cellular service provided by a wireless carrier system;
(b) detecting one or more failed attempts by the vehicle telematics unit to place the call;
(c) directing the vehicle telematics unit to begin using a different cellular profile including an International Mobile Subscriber Identity (IMSI) configured for a different wireless carrier system that is stored in a Universal Integrated Circuit Chip (UICC), wherein use of the different cellular profile is begun in response to the failed attempts to place the call and wherein the UICC stores a plurality of IMSIs each configured with a unique Mobile Subscription Identification Number (MSIN) that provides access to a particular wireless carrier system;
(d) providing information from the IMSI included in the different cellular profile to a cell tower; and
(e) placing the call from the vehicle telematics unit using the different cellular profile.

6. The method of claim 5, wherein the call results from an airbag activation or a call to a public safety access point (PSAP).

7. The method of claim 5, further comprising the step of wirelessly receiving the cellular profile, the different cellular profile, or both from a remote facility and storing the cellular profile(s) in the UICC.

8. A method of controlling selection of cellular profiles at a vehicle,
the steps comprising:
(a) storing a first cellular profile and a second cellular profile on a Universal Integrated Circuit Chip (UICC), wherein the first cellular profile includes an International Mobile Subscription Identity (IMSI) having a Mobile Subscription Identification Number (MSIN) that is configured for a wireless carrier system and the second cellular profile includes a different IMSI having a different MSIN configured for a different wireless carrier system;
(b) detecting a call at the vehicle equipped with a vehicle telematics unit that subscribes to cellular service provided by the wireless carrier system, wherein the vehicle telematics unit includes the UICC;
(c) determining that cellular service is unavailable at the vehicle telematics unit via the wireless carrier system;
(d) directing the vehicle telematics unit to stop using the first cellular profile and begin using the second cellular profile in response to steps (b) and (c);
(e) providing information from the IMSI included in the second cellular profile to a cell tower; and
(f) placing the call using the different cellular profile.

9. The method of claim 8, wherein the emergency call results from an airbag activation or a call to a public safety access point (PSAP).

10. The method of claim 8, further comprising the step of wirelessly receiving the first cellular profile, the second cellular profile, or both from a remote facility and storing the cellular profile(s) in the UICC.
